(19) United States
(12) Patent Application Publication
(10) Pub. No.: US 2012/0203544 A1
(43) Pub. Date: Aug. 9, 2012

(54) CORRECTING TYPING MISTAKES BASED ON PROBABILITIES OF INTENDED CONTACT FOR NON-CONTACTED KEYS

(75) Inventor: Clifford A. Kushler, Seattle, WA (US)

(73) Assignee: NUANCE COMMUNICATIONS, INC., Burlington, MA (US)

(21) Appl. No.: 13/366,225

(22) Filed: Feb. 3, 2012

Related U.S. Application Data
(60) Provisional application No. 61/462,587, filed on Feb. 4, 2011.

(51) Int. Cl. G06F 17/27

(52) U.S. Cl. 704/9

(57) ABSTRACT

Systems and methods for identifying word candidates based on a sequence of contact events within one or more keys on a keyboard. In some examples, the system identifies a probability of intended contact for keys adjacent to a contacted key, and returns the identified probabilities to a typing correction system that identifies likely word candidates that correspond to text input sequences.

### PRIORITY CLAIM

This application claims the benefit of U.S. Provisional Application Ser. No. 61/462,587 filed Feb. 4, 2011.

### BACKGROUND OF THE INVENTION

The origin of the modern keyboard as the primary method for inputting text from a human to a machine dates back to early typewriters in the 19th century. As computers were developed, it was a natural evolution to adapt the typewriter keyboard for use as the primary method for inputting text. For a skilled typist, it has remained the fastest way possible to input text into a computer or other data processing device.

With ongoing efforts to make computers smaller and more portable, the physical keyboard has become one of the most significant limiting factors in just how small a device can become: the physical size of the human finger is not something computer designers could change. As a result, computers for certain portable applications have been designed without a physical keyboard, and use touch-screen or other input methods as the primary form of the human computer interface. This is also the case for some applications where people are physically unable to use a keyboard, such as persons with physical disabilities.

There are various requirements for physical and virtual keyboard input methods, such as methods for mobile devices or other computing devices, which frequently conflict with each other. The method of input should be as fast as possible and the correction of typing mistakes should be efficient and easy to perform, while the input interface should take as little of the display screen as possible. Unfortunately, as the available space is decreased, it may become difficult to increase speed without adversely affecting accuracy.

Therefore, the need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### SUMMARY OF THE INVENTION

The present invention provides systems and methods device for presenting word candidates to a user based on a contact event within a key on a displayed keyboard. An exemplary system detects a contact event on a displayed keyboard or on a displayed candidate list. identifying whether the contact is a key tap of a key of the displayed keyboard, a path movement into a key of to the displayed keyboard, or a selection from a displayed candidate list. The system then determines whether the identified key is an alphabetic key or function key. When the identified key is an alphabetic key, the system updates a current input sequence with the identified key. The system identifies a group of one or more word candidates that correspond to the current input sequence. Identifying includes identifying a word as a candidate if each of its initial letters is associated with a corresponding activated key in the input sequence, identifying a word as a candidate if each of its initial letters is associated with a key that is adjacent to the corresponding activated key in the input sequence, and for one or more identified candidate words, reducing a probability that a candidate word is an intended word by a determined factor for each letter that is associated with an adjacent key. Then the system generates a tap candidate list of the identified group of one or more word candidates and displays the generated tap candidate list to a user via a display of the mobile device.

### BRIEF DESCRIPTION OF THE DRAWINGS

Preferred and alternative examples of the present invention are described in detail below with reference to the following drawings:

FIG. 1 is a block diagram illustrating components of a mobile device or other suitable computing device.

FIG. 2 is a block diagram illustrating components employed by an intended contact component system.

FIG. 3 is a flow diagram illustrating a routine for providing information to a typing correction system.

FIG. 4A is a flow diagram illustrating a routine for determining intended contact probabilities during a contact event based on shared borders between candidate keys and a contacted key.

FIG. 4B is a schematic diagram illustrating identified candidate keys following an example implementation of the routine of FIG. 4A.

FIG. 5A is a flow diagram illustrating a routine for determining intended contact probabilities during a contact event based on the overlap with a candidate key and a circle centered at the center of a contacted key that completely covers the contacted key without completely covering any adjacent keys or partially covering any non-adjacent keys.

FIG. 5B is a schematic diagram illustrating identified candidate keys following an example implementation of the routine of FIG. 5A.

FIG. 6A is a flow diagram illustrating a routine for determining intended contact probabilities during a contact event based on the overlap with a candidate key and a circle centered at the center of a contacted key that completely covers the contacted key without completely covering any adjacent keys.

FIG. 6B is a schematic diagram illustrating identified candidate keys following an example implementation of the routine of FIG. 6A.

FIG. 7A is a flow diagram illustrating a routine for determining intended contact probabilities during a contact event based on the overlap with a candidate key and a circle centered at a point of contact that completely covers the contacted key.

FIG. 7B is a schematic diagram illustrating identified candidate keys following an example implementation of the routine of FIG. 7A.

FIG. 8A is a flow diagram illustrating a routine for determining intended contact probabilities during a contact event based on the overlap with a candidate key and a circle centered at a point of contact having a pre-determined radius.

FIG. 8B is a schematic diagram illustrating identified candidate keys following an example implementation of the routine of FIG. 8A.

FIG. 9A is a flow diagram illustrating a routine for determining intended contact probabilities during a contact event based on the overlap with a candidate key and a circle centered at a point of contact having an area approximately the size of a fingertip that contacted the keyboard.

FIG. 9B is a schematic diagram illustrating identified candidate keys following an example implementation of the routine of FIG. 9A.

FIG. 10 is a flow diagram illustrating a routine for performing typing corrections.

### DETAILED DESCRIPTION OF THE PREFERRED EMBODIMENT

A system and method for presenting word candidates to a user during a text input sequence is described. In some embodiments, the system receives information associated with a contact event within a contacted key of a keyboard displayed by a touch-screen of the mobile device, which may cause a letter associated with the contacted key to be added to a current input sequence. The system identifies one or more key candidates for keys adjacent to the contacted key based on a determined relationship factor between the contacted key and the keys adjacent to the contacted key, and calculates probabilities of intended contact for each of the identified one or more key candidates. The system may then output the information to a text entry application or other application.

In some embodiments, a word identification component of a text entry application receives the outputted information and uses the information to identify a group of one or more word candidates that correspond to the current input sequence. For example, the word identification component may identify a word as a candidate if each of its letters is associated with the contacted key in the current input sequence and/or may identify a word as a candidate if each of its initial letters is associated with a key that is adjacent to the contacted key in the input sequence. The word identification component may reduce a probability that an identified word is a most likely word candidate based on the calculated probabilities of intended contact.

Thus, in some cases the system identifies a probability of intended contact for keys adjacent to a contacted key and returns the identified probabilities to a typing correction system or other system to improve the identification of likely word candidates that correspond to text input sequences, among other benefits.

The system will now be described with respect to various embodiments. The following description provides specific details for a thorough understanding of, and enabling description for, these embodiments of the system. However, one skilled in the art will understand that the system may be practiced without these details. In other instances, well-known structures and functions have not been shown or described in detail to avoid unnecessarily obscuring the description of the embodiments of the system.

It is intended that the terminology used in the description presented below be interpreted in its broadest reasonable manner, even though it is being used in conjunction with a detailed description of certain specific embodiments of the system. Certain terms may even be emphasized below; however, any terminology intended to be interpreted in any restricted manner will be overtly and specifically defined as such in this Detailed Description section.

Suitable System

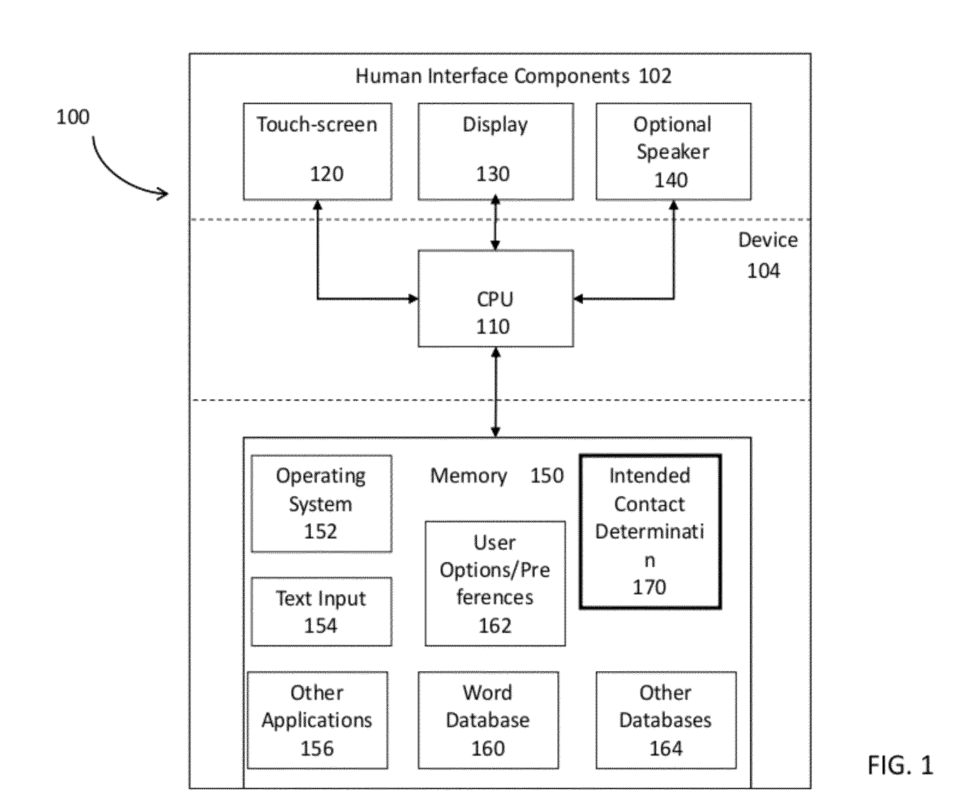

FIG. 1 illustrates a block diagram of a computing device 100 on which the typing correction system can be supported. The computing device 100 may be a mobile device, smart-phone, tablet computer, net-book, mobile GPS navigation device, remote control, fixed telephone or communications console or apparatus, surface or tabletop computer, overhead image projector, desktop computer, e-reader, ATM machine, vending machine, or any other device having a keyboard (e.g., any device having a physical keyboard or a virtual keyboard). The computing device 100 includes various hardware and/or components configured to provide information to a typing correction system and perform typing corrections for users of the computing device 100. The device 100 includes a touch-screen 120 or other input component that provides input to a processor 110, such as input notifying the processor 110 of contact events when the touch-screen is touched. The touch-screen may include or communicate with a hardware controller, such as a touch-screen driver, that interprets raw signals received from the touch-screen and transmits information associated with the contact event (e.g., indication of a button or key press, X-Y coordinates of a point of contact (such as from a finger or stylus touch on a touch screen, touch pad, or graphics tablet), a request by a user to press a physical or virtual key, the current position of a pointing input device, area of contact, pressure, duration, and so on) to the processor 110. For example, the hardware controller may transmit information associated with a variety of pointing devices, including a mouse, a trackball, a joystick or analog stick, a pointing stick or nipple mouse, a roller mouse, a foot mouse, a palm mouse, a light pen, a light gun, a positional gun, a laser pointer, a gyroscope or gyroscopic mouse, an accelerometer, an eye tracking device, a video tracking device, a stylus, and so on. The processor 110 communicates with a hardware controller or driver associated with a display 130 to display information (e.g., letters of contacted keys on a displayed keyboard) associated with detected contact events. The display 130 may be integrated into computing device 100, or may be a stand-alone device. Example displays 130 include a touchscreen display, a flat panel display, a cathode ray tube, an electronic ink display, a head-mounted display, a liquid crystal display, a light-emitting diode display, a plasma panel display, an electro-luminescent display, a vacuum fluorescent display, a digital projector, a laser projector, a heads-up display, and so on. The device 100 may include a speaker 140 that provides appropriate auditory signals to assist a user in navigating a displayed keyboard or other displayed component.

The processor 110 may communicate with data or applications stored in a memory component 150 of the device 100, which may include a combination of temporary and/or permanent storage, and both read-only and writable memory (random access memory or RAM), read-only memory (ROM), writable non-volatile memory such as FLASH memory, hard drives, floppy disks, SIM-based components, and so on. The memory component 150 includes various program components or modules, such as an operating system 152, various text input applications 154, and other applications or programs 156, such as applications downloaded to the device 100. Further, the memory component includes a typing correction component or system 170, to be discussed in greater detail herein.

The text input application may be a key tap application, a gesture or contact movement application, or any other application that facilitates the entry of text from a user. The text input application may cause the device to display a keyboard via touch-screen 120 and receive input via a displayed keyboard. The keyboard may be a physical keyboard or a virtual keyboard, such as any keyboard that is implemented on a touch-sensitive surface, such as a keyboard presented on a touch-sensitive display, a keyboard imprinted on a touch-sensitive surface, and so on. Example keyboards include a keyboard displayed on a monitor, a keyboard displayed on a touch screen, a keyboard optically projected onto a flat or curved surface, or a physical keyboard with electronically changeable key symbols integrated into the keys, and so on. Further details regarding suitable text input applications may be found in commonly-assigned U.S. Pat. No. 7,542,029, issued on Jun. 2, 2009, entitled SYSTEM AND METHOD FOR A USER INTERFACE FOR TEXT EDITING AND MENU SELECTION, which is incorporated by reference in its entirety.

The memory component 150 also includes data storage components, such as a word database 160 for the text input applications 154, a user data database 162, and other databases 164 that provide and/or store information for applications executed by the device 100.

The device 100 may include other components (not shown) that facilitate operation of the device and its various components, including other input or output components, a radio and/or other communication components, power components, a subscriber identity module (SIM), and so on. In general, the device 100 may store or contain any and all components, modules, or data files required or used in performing typing corrections for text input applications provided by the device 100.

FIG. 1 and the discussion herein provide a brief, general description of a suitable computing environment in which the typing correction system can be implemented. Although not required, aspects of the system are described in the general context of computer-executable instructions, such as routines executed by a general-purpose computer, e.g., mobile device, a server computer, or personal computer. Those skilled in the relevant art will appreciate that the system can be practiced with other communications, data processing, or computer system configurations, including: Internet appliances, hand-held devices (including personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a server computer, while corresponding portions reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

Determining Probabilities Associated with Contact Events being Intended Contact Events

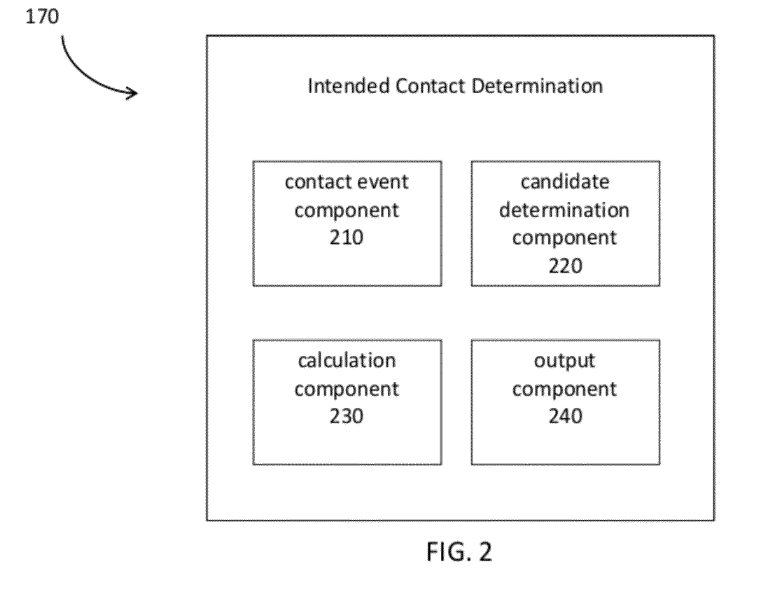

As discussed herein, the device 100 may include or store an intended contact determination component that provides information, such as probabilities associated with a contact event being an intended contact event, to a text input application 154, such as a key tap or path based text input application. FIG. 2 is a block diagram illustrating an intended contact determination component 170 employed by device typing correction system or other system facilitating the input of text to a device. The intended contact determination component 170 includes a contact event component 210 configured and/or programmed to receive information identifying and/or associated with a contact event at a contacted, pressed, or otherwise activated key of a displayed or other touch-sensitive keyboard, such as a virtual keyboard, physical keyboard, and so on. For example, the contact event component 210 may receive coordinate information (e.g., values for X and Y coordinates) associated with a contact event, or other information that indicates a location of contact during a contact event.

The intended contact determination component 170 also includes a key candidate determination component 220 that identifies candidate keys, which include keys other than the contacted key, and which may have been intended to be contacted by a user of the keyboard. For example, the candidate keys may be keys adjacent to a contacted key, keys proximate to the adjacent keys, keys on a path of movement over the keyboard, and so on. The key candidate determination component 220 may, therefore, determine a group of candidate keys as keys the user possibly intended to tap or move over on the keyboard.

A calculation component 230 receives information from the key candidate determination component 220, such as a group or list of candidate keys, and calculates and/or determines probabilities that one or more keys adjacent or proximate to a key receiving a contact event (e.g., key tap or path movement) within the key was the intended key for the contact event. The calculation component 230 transmits the calculated probabilities and/or other information to an output component 240, which provides the information to components of the typing correction system, in order to reduce a number of candidate words considered by a text input application during a contact event, among other benefits.

For example, a touchscreen input driver associated with a touch-screen 120 of a mobile device 100 transmits contact event information to the intended contact determination component 170, which performs one or more of the routines described herein to determine intended contact probabilities associated with keys adjacent or proximate to a key activated during the contact event. The intended contact determination component 170 may then provide the determined probabilities to a typing correction system, such as a system contained by or employed by the text input application 154.

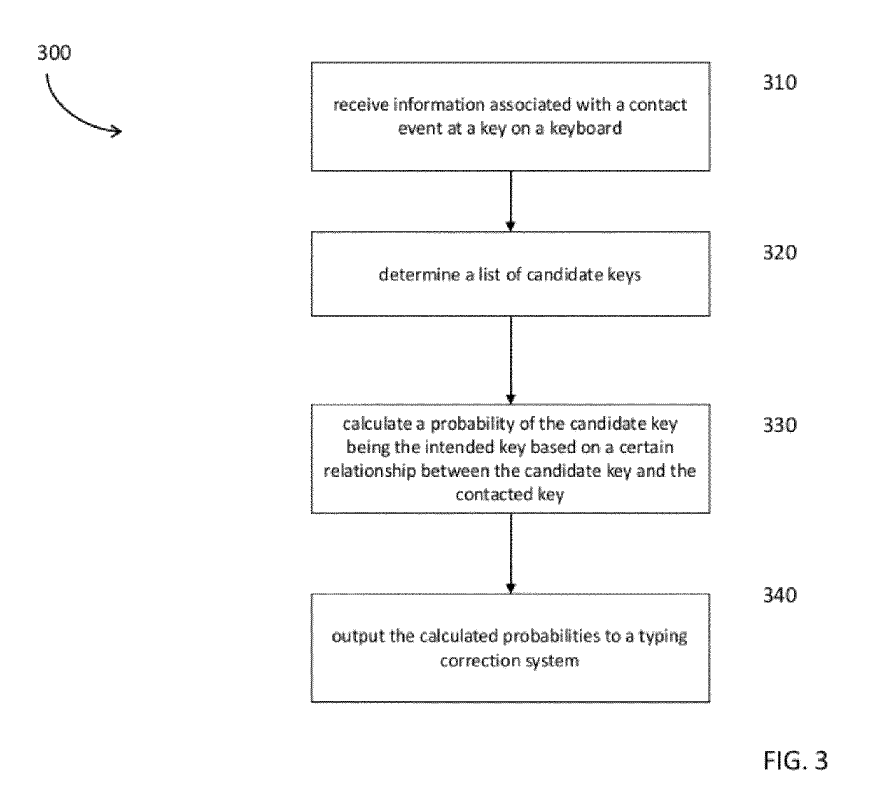

FIG. 3 is a flow diagram illustrating a routine 300 for providing information to a typing correction system, such as information associated with a probability that a key not activated during a contact event was the key intended to be contacted. In step 310, the system receives information associated with a contact event at a key on a keyboard. For example, the contact event component 210 may receive information from a touch-screen driver associated with the touch-screen 120. The information associated with the contact event may include a location or point of contact, an area or shape of the point of contact, a duration of the contact event, a direction or movement of the contact event, a pressure of contact, a key activated by the contact event, and/or other information associated with the contact event.

In some cases, a contact event may be a physical touching or selection of a region of a keyboard, such as a key of a keyboard. Some examples of physical contact events include pressing or tapping a button, key, or displayed key, making a verbally recognized keypress request, dwelling the location of a pointing device within a defined region for a period of time exceeding a threshold, and so on.

In some cases, a contact event may be virtual, in that actual physical contact between a user and a keyboard does not occur, although there is a contact event. Some examples of virtual contact events include a user moving a finger next to a touchscreen employing infrared detection of finger proximity, a user aiming a pointing device at a keyboard while indicating a request to press a key, and so on.

In step 320, the system determines a list of candidate keys. For example, in response to receiving contact event information such as information identifying the key activated during the contact event, the candidate determination component 220 identifies one or more non-activated keys as candidate keys intended to be activated during the contact event. The candidate keys may be any keys displayed by the keyboard, a certain region of keys associated with an activated key, keys adjacent to an activated key, keys proximate to an activated key, keys that share a border with the activated key, keys that overlap with circles of varying radii centered on an activated key, keys that overlap with circles of varying radii centered on a point of contact on the activated key, various permutations or combinations of set of keys, keys adjacent to candidate keys, and so on.

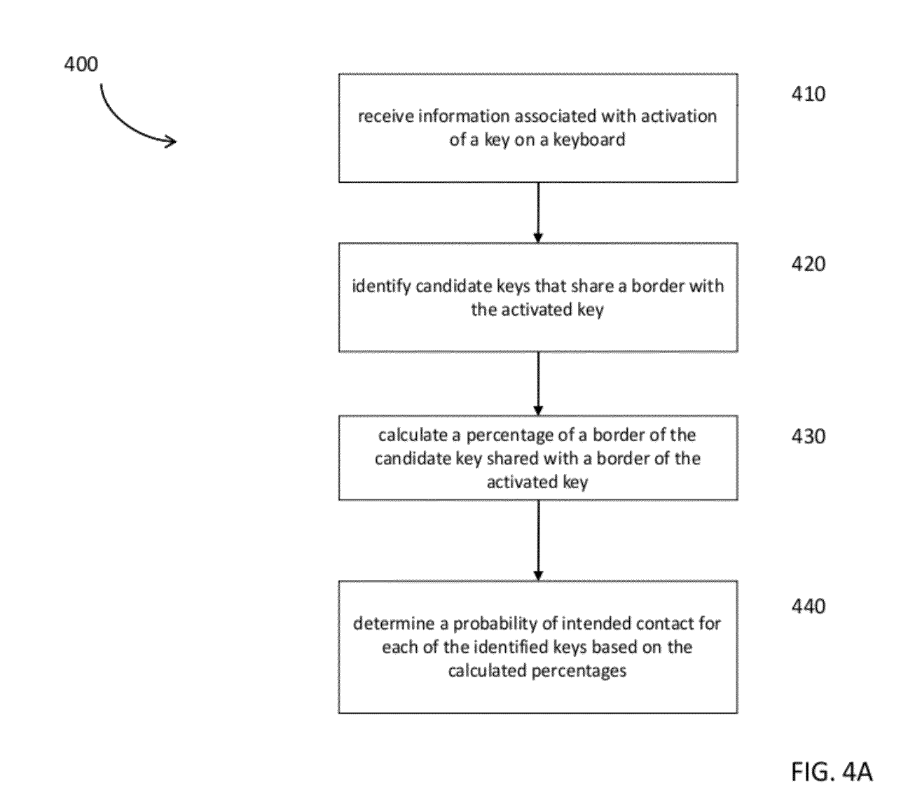

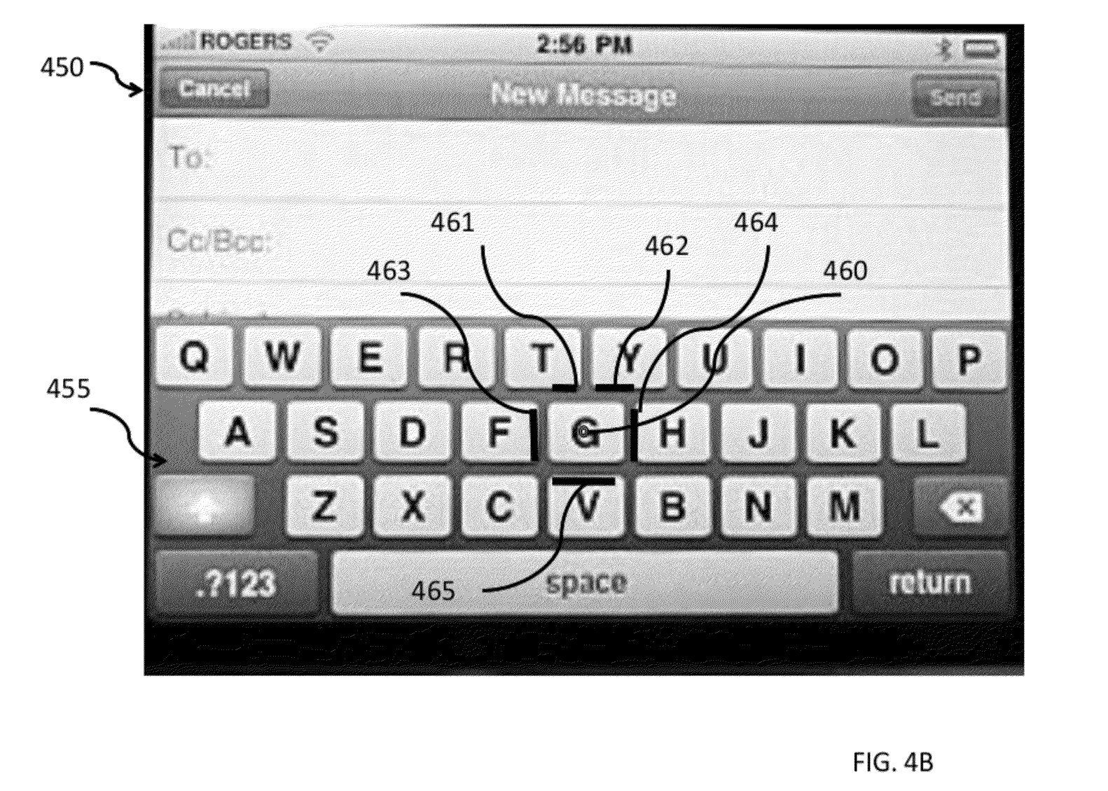

In step 330, the system, for some or all of the candidate keys, calculates a probability that the candidate key is an intended key based on a certain relationship between the candidate key and the key activated during the contact event. For example, the calculation component 230 may calculate a probability of intended contact for a candidate key based on a length or percentage of an activated key's border shared with the candidate key, based on an area of overlap between the candidate key and a circle centered on the activated key and radiating a certain distance over the keyboard, and so on. Further details and examples associated with the identification of candidate keys and the calculation of probabilities will be discussed with respect to FIG. 4A-10B.

In step 340, the system outputs the calculated probabilities to a typing correction system, such as a system that fixes errors within a text input application. For example, the output component 240 may output the probability information to a text input application to facilitate the text input application to reduce a list of candidate words considered to be possible words being input by a user of the application.

Thus, the system, in some cases, modifies or determines the likelihood that a key contact within the boundaries of a given key should be processed and or interpreted by a text input application as an activation of an alternate key the user may have intended to the given key. FIGS. 4A-10B describe various routines employed by the system to determine such likelihoods.

In some embodiments, the intended contact determination component 170 may provide probabilities based on a sharing of borders between keys. FIGS. 4A-10B are, respectively, a flow diagram and accompanying schematic diagram illustrating a routine 400 for determining intended contact probabilities during a contact event based on shared borders between candidate keys and a contacted key.

In step 410 of FIG. 4A, the routine 400 receives information associated with activation of a key on a keyboard. The routine 400 may receive information identifying the key activated during a contact event while a user is inputting text. For example, FIG. 4B depicts a touch-screen 450 having a displayed keyboard 455 with a contact event occurring at a point of contact 460 within the boundaries of the “G” key.

In step 420, the routine 400 identifies candidate keys as the keys that share a border with the activated key. Following the example, FIG. 4B depicts five keys that share a border with the “G” key: the “H” key and the “F” key located on the same row as the “G” key, the “V” key directly below the “G” key, the “T” key above the left corner of the “G” key, and the “Y” key above the right corner of the “G” key.

In step 430, the routine 400 calculates a percentage of a border that an activated key shares with a border of a candidate key. Following the example, FIG. 4B depicts the various borders shared between the “G” keys and the adjacent keys. In the example, the “T” key shares 15% of the “G” key's border 461, the “Y” key shares 15% of the “G” key's border 462, the “F” key shares 20% of the “G” key's border 463, the “H” key shares 20% of the “G” key's border 464, and the “V” key shares 30% of the “G” key's border 465.

In step 440, the routine 400 determines a probability of intended contact for each of the identified keys based, at least in part, on the calculated percentages. The routine 400 may determine the probability based on any number of equations or algorithms, such as:

Probability=(multiplying factor for non-activated key)*(percentage of shared border)

Thus, if the multiplying factor is 0.7 for all non-activated keys, then the following probabilities of intended contact would be determined for the contact event depicted in FIG. 4B:
Probability of “T” key=0.7(0.15)=0.105
Probability of “Y” key=0.7(0.15)=0.105
Probability of “F” key=0.7(0.2)=0.14
Probability of “H” key=0.7(0.2)=0.14
Probability of “V” key=0.7(0.3)=0.21

Of course, other equations, variables, or factors may be employed. For example, the position of a key, such as its horizontal or vertical position relative to an activated key, may be considered when determining a probability of adjacent key. In some cases, the routine 400 and other routines described herein may only consider certain candidate keys that share a border with an activated key, such as the keys within the same row as an activated key. In some cases, the routine 400 may provide a certain multiplying factor for adjacent keys in the same row as an activated key, and a different multiplying factor for keys above or below an activated key.

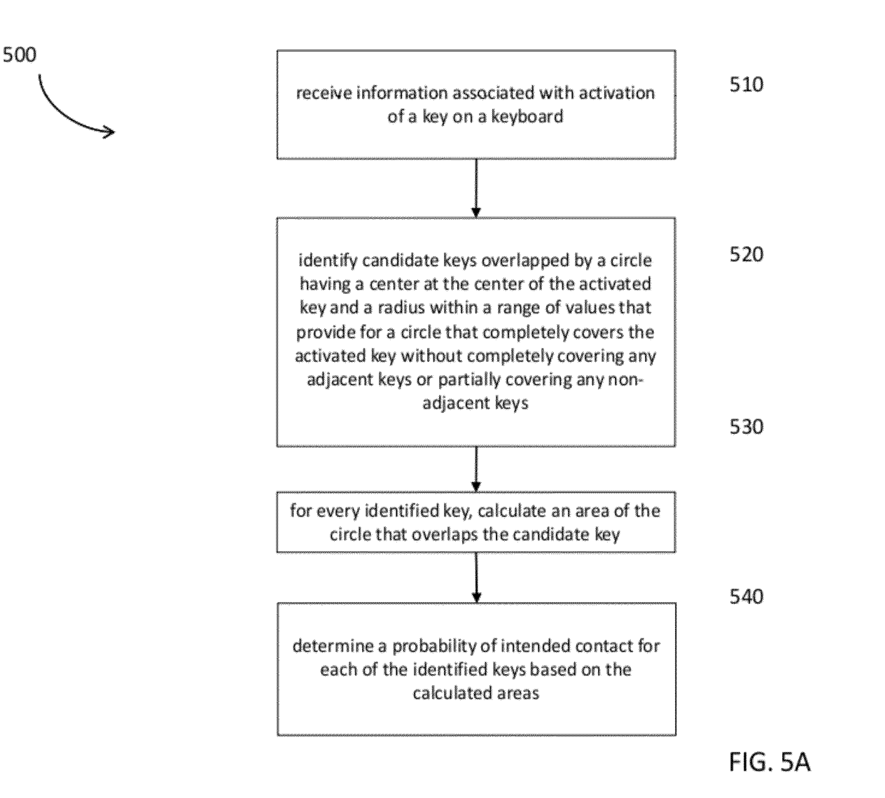

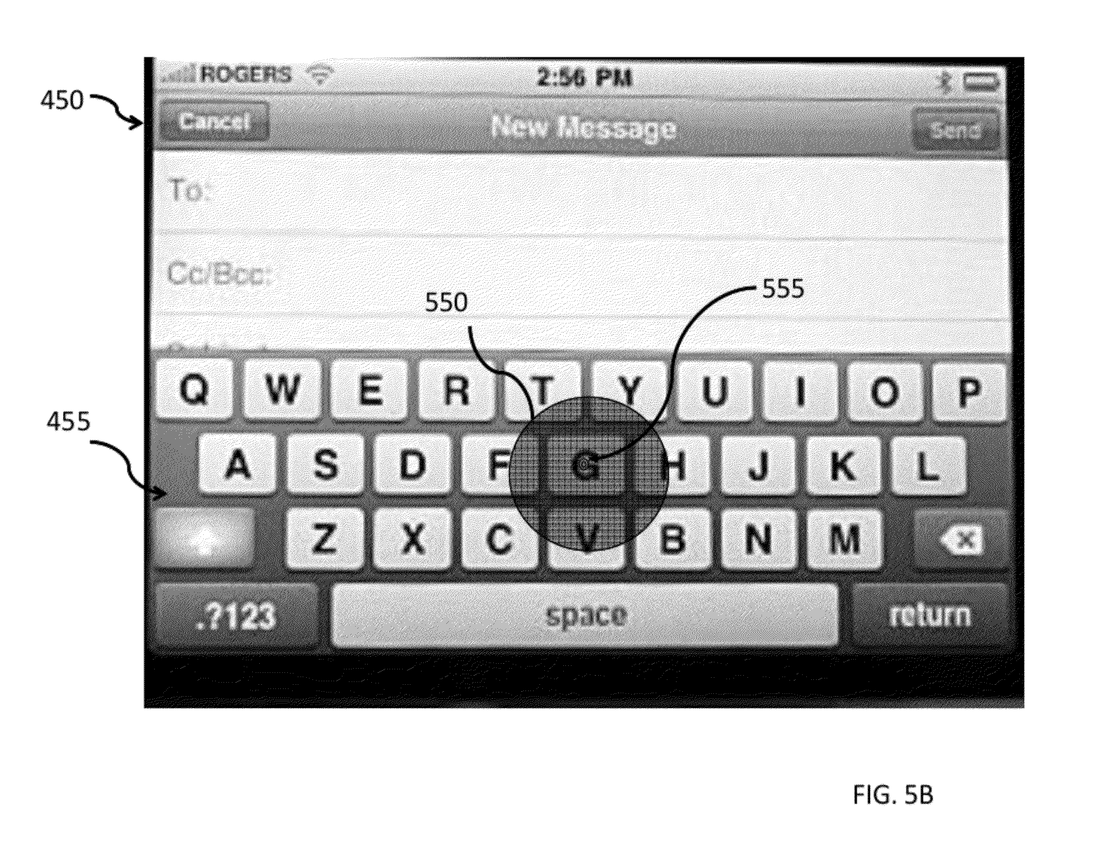

In some embodiments, the intended contact determination component 170 may provide probabilities based on the overlap of a circle centered at a contacted key with adjacent or proximate keys. FIGS. 5A-5B are, respectively, a flow diagram and a schematic diagram illustrating a routine 500 for determining intended contact probabilities during a contact event based on the overlap with a candidate key and a circle centered at the center of a contacted key that completely covers the contacted key without completely covering any adjacent keys or partially covering any non-adjacent keys.

In step 510 of FIG. 5A, the routine 500 receives information associated with activation of a key on a keyboard. The routine 500 may receive information identifying the key activated during a contact event while a user is inputting text. For example, FIG. 5B depicts a touch-screen 450 having a displayed keyboard 455 with a contact event occurring at a point of contact 555 within the boundaries of the “G” key.

In step 520, the routine 500 identifies candidate keys as the keys that overlap with a circle centered at the center of a contacted key 560 that completely covers the contacted key without completely covering any adjacent keys or partially covering any non-adjacent keys. Following the example, FIG. 5B depicts seven keys that overlap with a circle 550 centered at the center of the “G” key: the “H” key and the “F” key located on the same row as the “G” key, the “V” key, the “C” key, and the “B” key below the “G” key, and the “T” key and the “Y” key above the “G” key.

In step 530, the routine 500 calculates a percentage of the area of overlap between the circle 550 and the candidate keys. In the example, 25% of the “T” key and the “Y” overlaps with the circle 550, 35% of the “F” key, “H” key, and “V” key overlaps with the circle 550, and 10% of the “C” key and the “B” key overlaps with the circle 550.

In step 540, the routine 500 determines a probability of intended contact for each of the identified keys based, at least in part, on the calculated percentages. The routine 500 may determine the probability based on any number of equations or algorithms, such as equations similar to those described above with respect to FIG. 4A. Of course, other equations, variables, or factors may be employed.

Thus, when a contact is detected within a given key, routine 500 weighs the likelihood that the key activation was actually intended to be on an adjacent key as a function of the area of overlap between the adjacent key and a circle whose center is located at the center of the activated key, where the radius of the circle is at least large enough to completely encompass the area of the activated key, but not so large as to completely encompass any adjacent key or to partially encompass any key that does not share any boundary with the activated key.

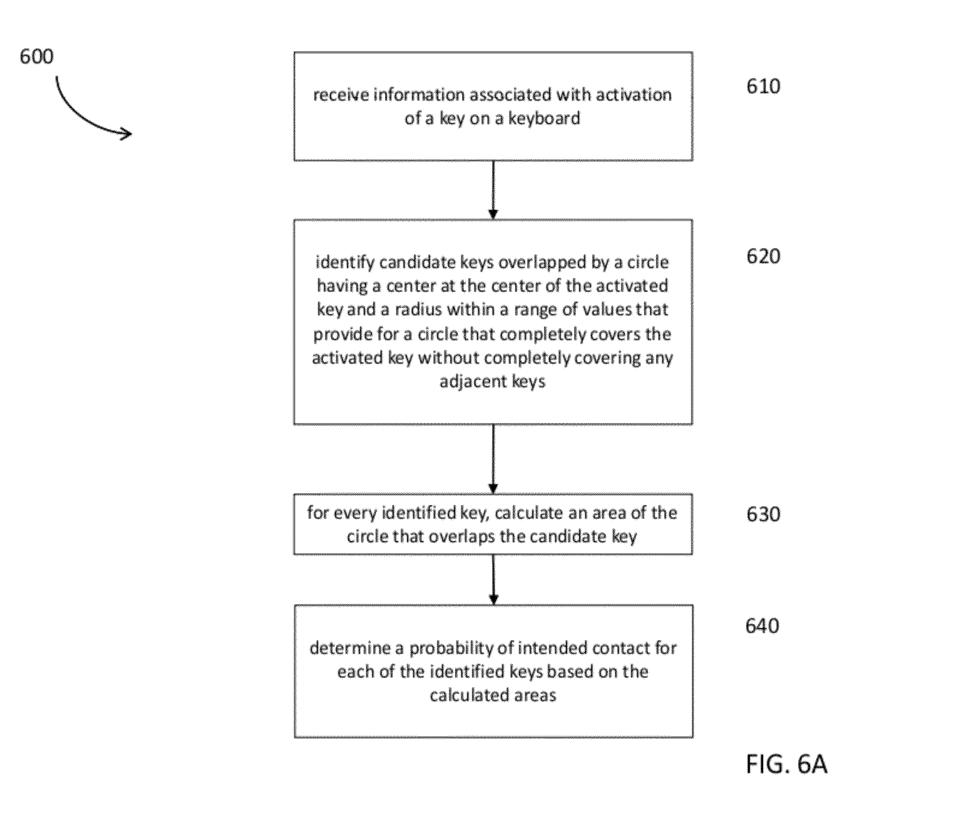

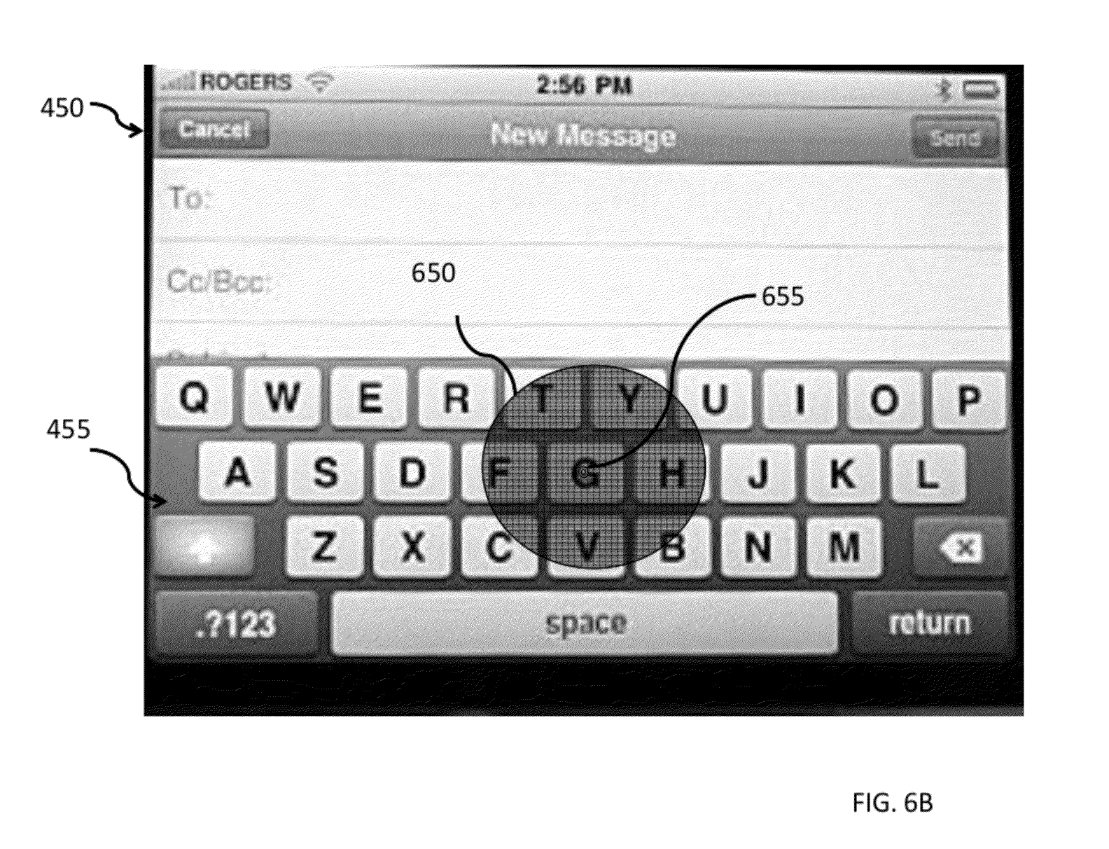

FIGS. 6A-6B are, respectively, a flow diagram and a schematic diagram illustrating a routine for determining intended contact probabilities during a contact event based on the overlap with a candidate key and a circle centered at the center of a contacted key that completely covers the contacted key without completely covering any adjacent keys.

In step 610 of FIG. 6A, the routine 600 receives information associated with activation of a key on a keyboard. The routine 600 may receive information identifying the key activated during a contact event while a user is inputting text. For example, FIG. 6B depicts a touch-screen 450 having a displayed keyboard 455 with a contact event occurring at a point of contact 655 within the boundaries of the “G” key.

In step 620, the routine 600 identifies candidate keys as the keys that overlap with a circle centered at the center of a contacted key that completely covers the contacted key without completely covering any adjacent keys, but may partially cover any non-adjacent keys. Following the example, FIG. 6B depicts nine keys that overlap with a circle 650 centered at the center of the “G” key: the “H” key and the “F” key located on the same row as the “G” key, the “V” key, the “C” key, and the “B” key below the “G” key, and the “R” key, the “T” key, the “Y” key, and the “U” key above the “G” key.

In step 630, the routine 600 calculates a percentage of the area of overlap between the circle 650 and the candidate keys. In the example, 90% of the “T” key and the “Y” key overlaps with the circle 650, 95% of the “F” key and the “H” key overlaps with the circle 650, 92% of the “V” key overlaps with the circle 650, 30% of the “C” key and the “B” key overlaps with the circle 650, and 5% of the “R” key and the “U” key overlaps with the circle 650.

In step 640, the routine 600 determines a probability of intended contact for each of the identified keys based, at least in part, on the calculated percentages. The routine 600 may determine the probability based on any number of equations or algorithms, such as equations similar to those described above with respect to FIG. 4A. Of course, other equations, variables, or factors may be employed.

Thus, when a contact is detected within a given key, routine 600 weighs the likelihood that the key activation was actually intended to be on a nearby or adjacent key as a function of the area of overlap between the adjacent key and a circle whose center is located at the center of the activated key, where the radius of the circle is at least large enough to completely encompass the area of the activated key, but not so large as to completely encompass any adjacent key. In some cases the circle may partially encompass a key that does not share any boundary with the activated key (e.g., the circle 650 partially overlaps the “R” key without completely covering the “H” key).

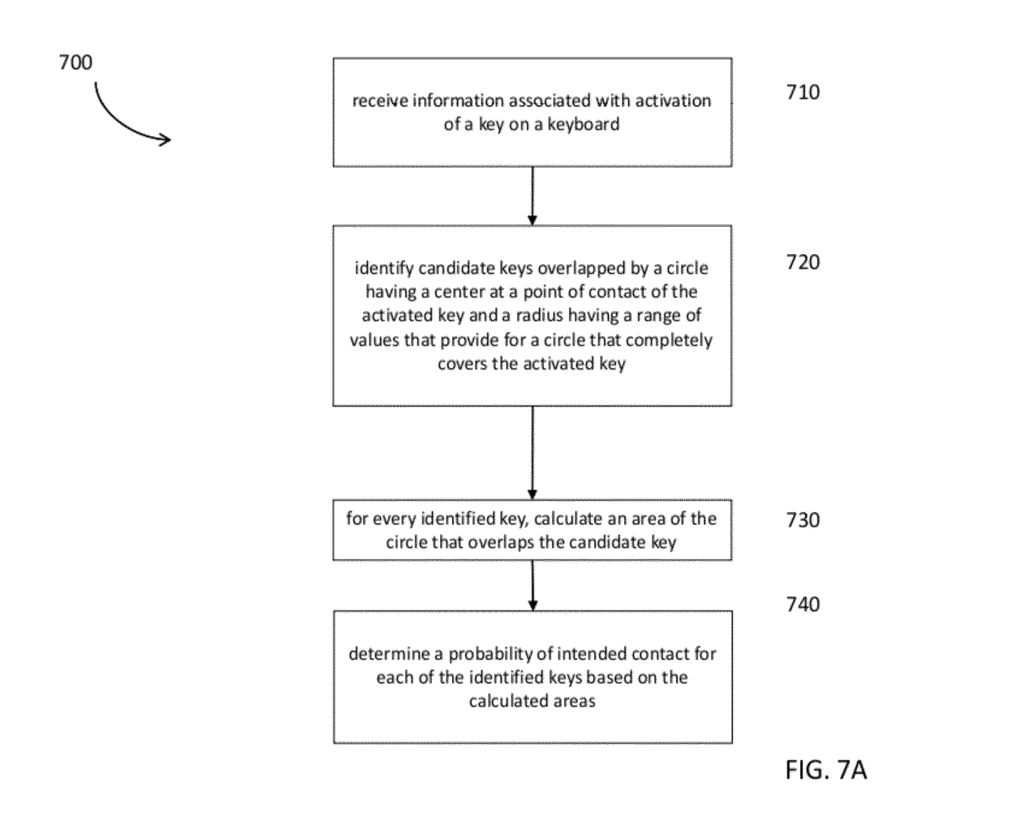

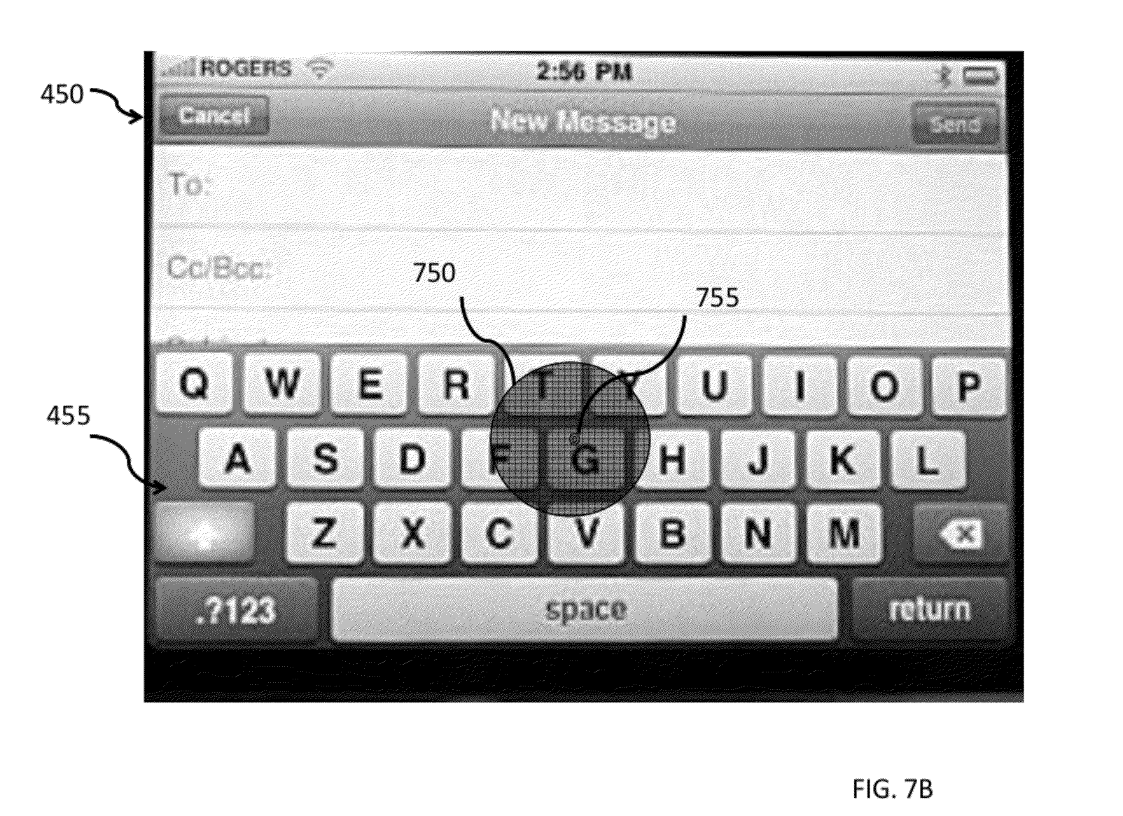

FIGS. 7A-7B are, respectively, a flow diagram and schematic diagram illustrating a routine 700 for determining intended contact probabilities during a contact event based on the overlap with a candidate key and a circle centered at a point of contact that completely covers the contacted key.

In step 710 of FIG. 7A, the routine 700 receives information associated with activation of a key on a keyboard. The routine 700 may receive information identifying the key activated during a contact event while a user is inputting text as well as information identifying an exact or approximate point of contact (or centroid of contact) within the activated key. For example, FIG. 7B depicts a touch-screen 450 having a displayed keyboard 455 with a contact event occurring at a point of contact 755 within the boundaries of the “G” key.

In step 720, the routine 700 identifies candidate keys as the keys that overlap with a circle centered at the point of contact 755 within the contacted key that completely covers the contacted key. Following the example, FIG. 7B depicts seven keys that overlap with a circle 750 centered at the point of contact 755 within the “G” key: the “H” key and the “F” key located on the same row as the “G” key, the “V” key and the “C” key below the “G” key, and the “R” key, the “T” key, and the “Y” key above the “G” key.

In step 730, the routine 700 calculates a percentage of the area of overlap between the circle 750 and the candidate keys. In the example, 65% of the “T” key overlaps with the circle 750, 60% of the “F” key overlaps with the circle 750, 45% of the “Y” key overlaps with the circle 750, 20% of the “H” key overlaps with the circle 750, 10% of the “V” overlaps with the circle 750, 3% of the “C” key overlaps with the circle 750, and 1% of the “R” key overlaps with the circle 750.

In step 740, the routine 700 determines a probability of intended contact for each of the identified keys based, at least in part, on the calculated percentages. The routine 700 may determine the probability based on any number of equations or algorithms, such as equations similar to those described above with respect to FIG. 4A. Of course, other equations, variables, or factors may be employed.

Thus, when a contact is detected on the keyboard, the routine 700 weighs the likelihood that the key activation was actually intended to be on a non-contacted, candidate key as a function of the area of overlap between the candidate key and a circle whose center is located at the detected point of contact, where the radius of the circle is at least large enough to completely encompass the area of the key within which the contact was detected.

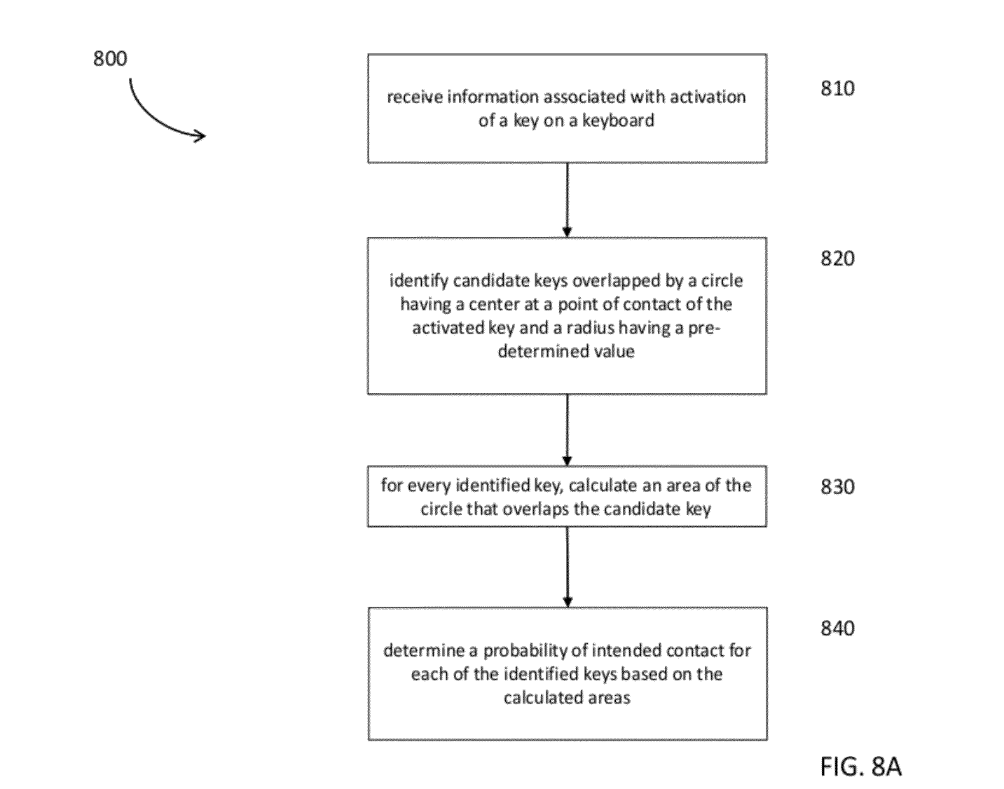

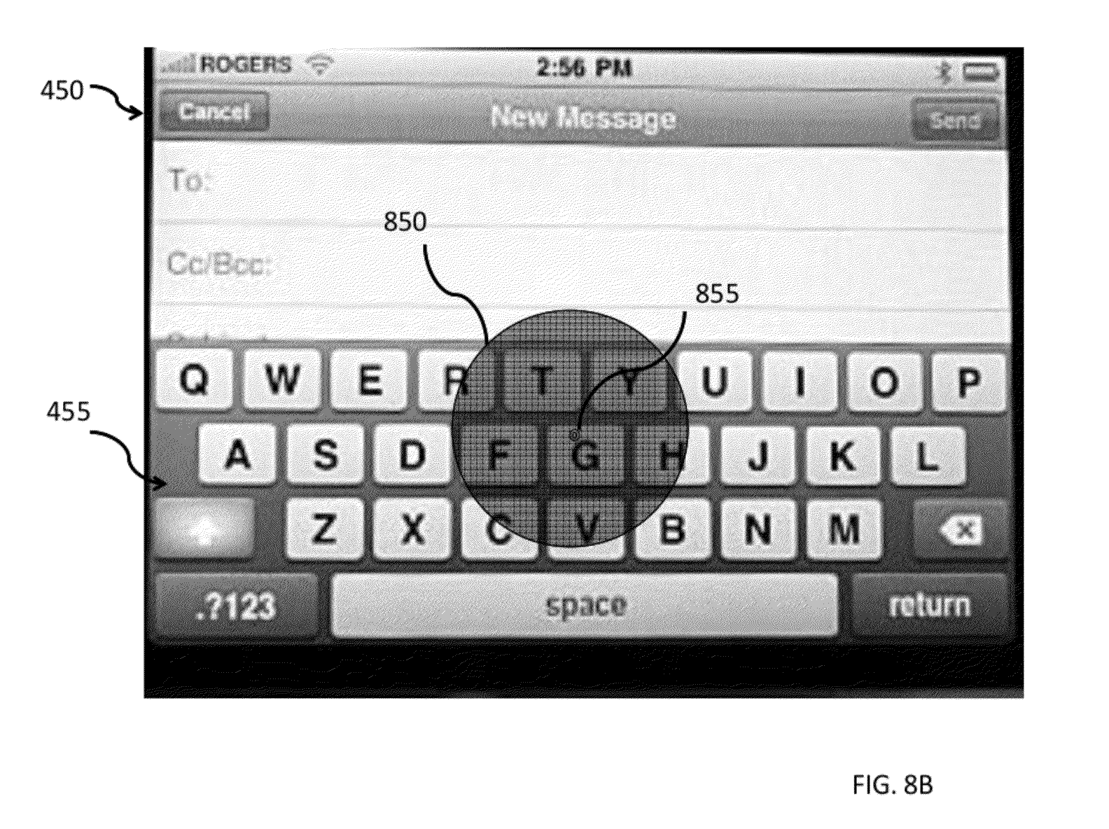

FIGS. 8A-8B are, respectively, a flow diagram and a schematic diagram illustrating a routine 800 for determining intended contact probabilities during a contact event based on the overlap with a candidate key and a circle centered at a point of contact having a pre-determined radius.

In step 810 of FIG. 8A, the routine 800 receives information associated with activation of a key on a keyboard. The routine 800 may receive information identifying the key activated during a contact event while a user is inputting text as well as information identifying an exact or approximate point of contact (or centroid of contact) within the activated key. For example, FIG. 8B depicts a touch-screen 450 having a displayed keyboard 455 with a contact event occurring at a point of contact 855 within the boundaries of the “G” key.

In step 820, the routine 800 identifies candidate keys as the keys that overlap with a circle centered at the point of contact 855 within the contacted key having a radius of a pre-determined value. Following the example, FIG. 8B depicts nine keys that overlap with a circle 850 centered at the point of contact 855 within the “G” key and having a large radius: the “H” key and the “F” key located on the same row as the “G” key, the “V” key, the “C” key, and the “B” key below the “G” key, and the “R” key, the “T” key, the “Y” key, and the “U” key above the “G” key.

In step 830, the routine 800 calculates a percentage of the area of overlap between the circle 850 and the candidate keys. In the example, 100% of the “T” key overlaps with the circle 850, 97% of the “F” key overlaps with the circle 850, 99% of the “Y” key overlaps with the circle 850, 60% of the “H” key overlaps with the circle 850, 70% of the “V” overlaps with the circle 850, 33% of the “C” key overlaps with the circle 850, 35% of the “R” key overlaps with the circle 850, 15% of the “B” key overlaps with the circle 850, and 5% of the “U” key overlaps with the circle 850.

In step 840, the routine 800 determines a probability of intended contact for each of the identified keys based, at least in part, on the calculated percentages. The routine 800 may determine the probability based on any number of equations or algorithms, such as equations similar to those described above with respect to FIG. 4A. Of course, other equations, variables, or factors may be employed.

Thus, when a contact is detected on the keyboard, the routine 800 weighs the likelihood that the key activation was actually intended to be on a given key as a function of the area of overlap between the key and a circle whose center is located at the detected point of contact, where the radius of the circle is set to a pre-determined value.

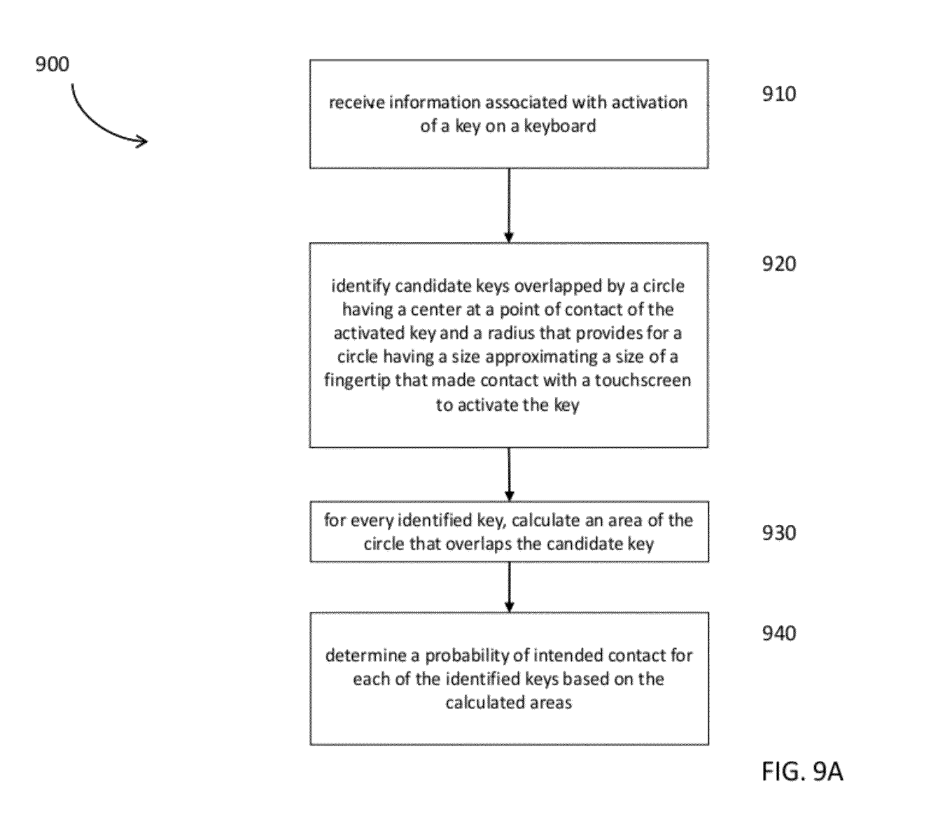

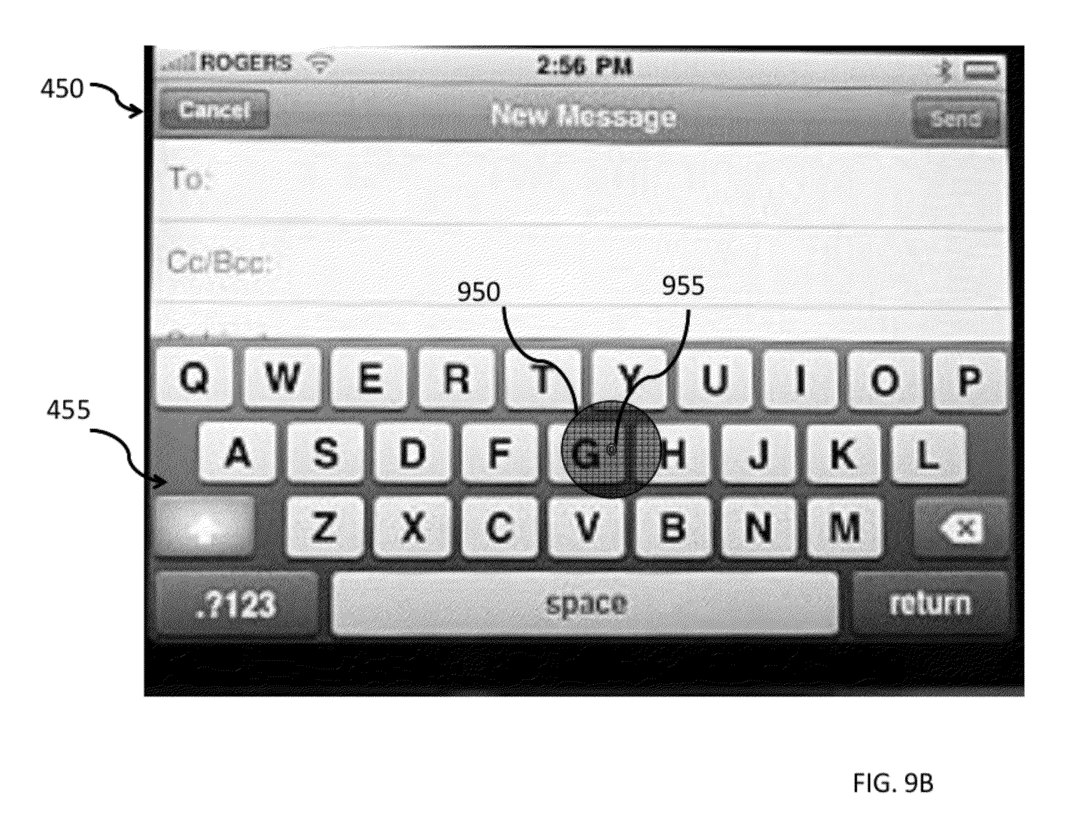

FIGS. 9A-9B are, respectively, a flow diagram and a schematic diagram illustrating a routine 900 for determining intended contact probabilities during a contact event based on the overlap with a candidate key and a circle centered at a point of contact having an area approximately the size of a fingertip that contacted the keyboard.

In step 910 of FIG. 9A, the routine 900 receives information associated with activation of a key on a keyboard. The routine 900 may receive information identifying the key activated during a contact event while a user is inputting text as well as information identifying an exact or approximate point of contact (or centroid of contact) within the activated key and information identifying a region or error associated with the contact event, such as the size of a fingertip that made contact with the activated key. For example, FIG. 9B depicts a touch-screen 450 having a displayed keyboard 455 with a contact event occurring at a point of contact 955 within the boundaries of the “G” key.

In step 920, the routine 900 identifies candidate keys as the keys that overlap with a circle centered at the point of contact 855 and having a radius that provides a circle of a size approximate to a size of a fingertip that made contact with the touch-screen. Following the example, FIG. 9B depicts two keys that overlap with a circle 950 centered at the point of contact 955 within the “G” key and having a area approximating the contact area of a fingertip on the touch-screen: the “H” key and the “Y” key.

In step 930, the routine 900 calculates a percentage of the area of overlap between the circle 950 and the candidate keys. In the example, 30% of the “H” key overlaps the circle 950 and 15% of the “Y” key overlaps the circle 950.

In step 940, the routine 900 determines a probability of intended contact for each of the identified keys based, at least in part, on the calculated percentages. The routine 900 may determine the probability based on any number of equations or algorithms, such as equations similar to those described above with respect to FIG. 4A. Of course, other equations, variables, or factors may be employed.

Thus, when a contact is detected on the keyboard, the routine 900 weighs the likelihood that the key activation was actually intended to be on a given key as a function of the area of overlap between the key and a circle whose center is located at the detected point of contact, where the radius of the circle approximates the radius of the area covered by the fingertip in contact with a touch-screen.

In some embodiments, information associated with the error tolerance of an input device, such as fingertip size, may be used to determine the size of a circle, which may be used to determine overlapping candidate keys and to calculate probabilities of intended contact. Other information may include noise, jitter, or shakiness patterns and histograms associated with accelerometer based pointing devices, laser pointers, and other pointing devices.

In some embodiments, the system and the various routines described herein may consider or employ other or additional factors when determining intended contact probabilities for non-activated keys. For example, the system may determine probabilities based on areas of overlap between an ellipse or other shapes having a center or focus at a point of contact, at the center of a contacted key, at adjacent keys, and so on.

In some embodiments, the system may some or all aspects of the routines described herein to determine candidate key lists and calculate probabilities of intended contact, and/or may combine the probabilities and lists of key candidates and output the combined intended contact probabilities to a typing correction system. For example, the system may determine intended contact probabilities during a contact event based on the shared borders between candidate keys (e.g., following some or all of the steps of routine 400) and a contacted key intersecting a circle centered at the point of contact having a pre-determined radius (e.g., following some or all of the steps of routine 700). That is, the system may combine some or all of the steps within the routines discussed herein when calculating probabilities of intended contact for any keys on a keyboard.

Additionally, the system and the various routines described herein may consider or employ other information associated with text input when determining intended contact probabilities for non-activated keys. For example, the system may select a value for a radius of an overlapping circle based on the speed of text entry or the speed of path movement. That is, the system may select a routine that generates a relatively large circle when a user is rapidly typing under the assumption the user is likely to make typing mistakes that are not precise. As another example, the system may utilize historical information associated with a user or with a given key when selecting a routine to employ. For example, the system may receive information that indicates a user generally taps keys at or near the center of the keys and employ a routine that centers overlapping circles at the centers of the keys.

Regardless of the routine, method, and/or process employed, the system in some embodiments, may transmit or communicate the determined probability information to various applications, including a typing correction system for use with a text input application. Further details will now be discussed.

Typing Corrections Based on Intended Contact Probabilities of Non-Contacted Keys

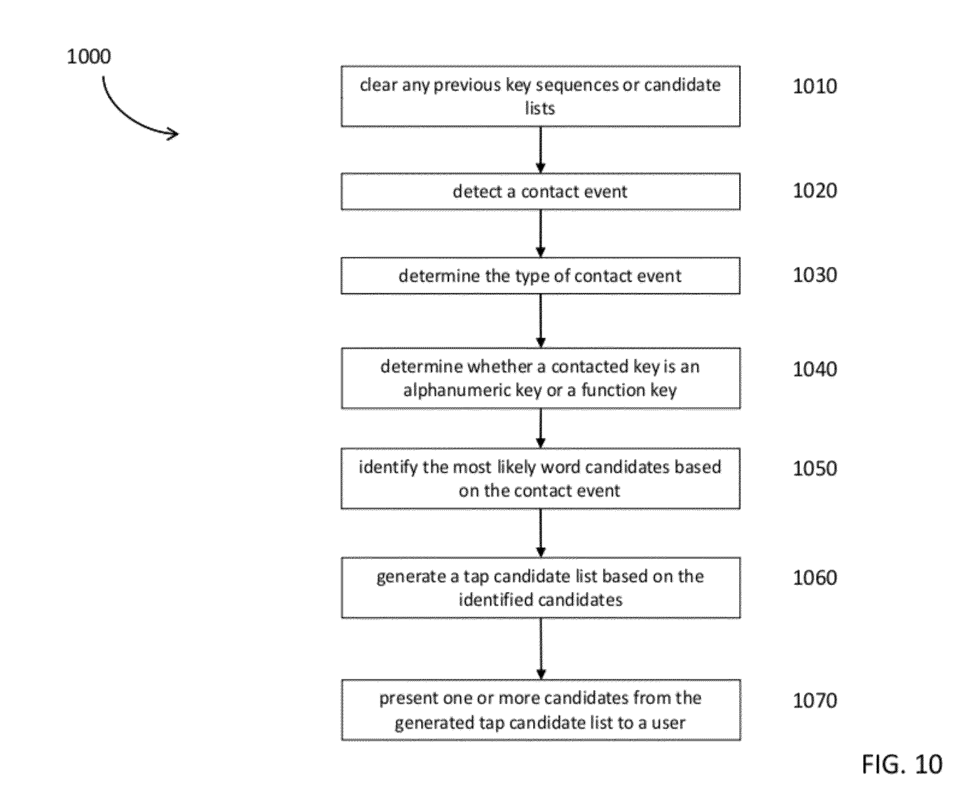

As discussed herein, in some embodiments, a typing correction system receives information from the intended contact determination component 170 and reduces a word candidate list in a text input application based on the received information. FIG. 10 is a flow diagram illustrating a routine 1000 for performing typing corrections based on intended contact probabilities for non-contacted keys.

In step 1010, a text input system, such as a text entry application, initializes by clearing any input key sequences or candidate lists. In step 1020, the system detects a contact event on a displayed keyboard 455 or a displayed candidate list. The system, in step 1030, may determine whether the contact is a key tap or a path movement on the keyboard, or a selection from a displayed candidate list. For a key tap, the system may identify a key region within which the tap occurred. For a path movement, if there is a non-empty input sequence and a corresponding list of candidate words, the system may output a default word and clear the input sequence, or may output a space, and generate an output word or word candidate list according to various algorithms performed by a path movement text entry application. For a candidate list selection the system may output a space and then output the selected word, clearing the input sequence and candidate list. When the selected word is an “activated text” word, the system may optionally and/or automatically add the word to the word database 160.

In step 1040, the system determines whether the identified key is an alphabetic key or function key. When the system determines the identified key is a function key, the system executes the function associated with the key (e.g., when the Space key is activated, the system may output the default word from a current list of candidate words (if any), and then output a space). When the system outputs a word, the system may clear the input key sequence and the routine 1000 returns to step 1010. When one or more keys are in the input key sequence (e.g., after a backspace, the input key sequence may be shorter but non-empty), the routine 1000 proceeds to step 1050. When the system determines the identified key is an alphabetic key, the system adds the current activated alphabetic key to the input key sequence, and the routine 1000 proceeds to step 1050.

In step 1050, the system identifies the most likely word candidate(s) in the database corresponding to a current input sequence, where the input sequence is of length N (greater than or equal to 1). The routine 1000, at step 1050, may perform some or all of the following functions when identifying likely word candidate(s).

In some cases, the system identifies a word as a candidate if one or more of its initial letters is associated with a corresponding key in the input sequence, or with a key that is adjacent to the corresponding key in the input sequence. For example, the Kth letter corresponds with the Kth key in the input sequence, or if the Jth letter has been omitted in the key sequence entered to spell the intended word, then for K>=J, the (K+1)th letter will correspond to the Kth key in the input sequence, or if the Jth key activated corresponds to an additional letter incorrectly inserted in the entered spelling for the intended word, then for K>=J, the Kth letter will correspond to the (K+1)th key in the input sequence.

In some cases, the system reduces the probability that a candidate word is the intended word by a determined factor for each letter that is associated with a candidate key (rather than the activated key). For example, the system may include and/or perform some or all of the routines described herein with respect to the intended contact determination component 170 in order to determine and reduce probabilities for letters associated with candidate keys.

In some cases, the system reduces the probability that a candidate word is the intended word by a determined factor for each letter that is omitted from the input sequence.

In some cases, the system reduces the probability that a candidate word is the intended word by a determined factor for each additional letter that is inserted in the input sequence.

In some cases, the system reduces the probability that a candidate word is the intended word by a determined factor if the candidate word is of length (N+M), where M is greater than a determined threshold (e.g. when the candidate word is much longer than the current input key sequence).

In some cases, the system increases the probability that a candidate word is the intended word by a determined factor if the final letter or letter sequence of the candidate word is found to correspond with the final key or key sequence of the input sequence.

In some cases, the system increases the probability that a candidate word is the intended word by a determined factor based on the relative frequency of use of the candidate word with respect to other words in the database.

In step 1060 the system creates a tap candidate list of one or more of the most probable words identified in step 1050. The tap candidate list will likely be non-empty, because in cases where no words are identified in the database that correspond to an input key sequence, a candidate list entry will be generated that includes the sequence of letters associated with the sequence of activated keys (the “activated text”).

In step 1070, the system presents one or more of the words in the tap candidate list to a user, such as a user inputting text. For example, the system may present the list as a graphical object overlain on a displayed keyboard, allowing for easy navigation to and within the list of words. The system may present the single most-probable candidate word “in place” at the insertion point where text is being entered in a text field, may present a list of two or more of the most-probable candidate words to the user for selection of an intended word, and so on.

Thus, a text entry application or other system that facilitates the input of text may enhance or improve the identification of candidate words during text input by employing some or all of the routines and components described herein, among other benefits.

Other Applications

Of course, other applications may employ and/or benefit from the routines and components described herein. For example, an application that receives credentials from a user, such as a webpage or application that receives text input associated with a user name and password from a user in order to authorize the user may employ some or all of the routines and components described herein.

Following the example, an access authorization application receives input from a user associated with a user name and password for the user. During entry of text associated with the password, the user makes an unrealized typing mistake, as the password is only shown as dots to the user for security purposes. The application, using one of the routines described herein, may determine a high probability that, during the typing mistake, the user intended to strike a key adjacent to the key activated during the typing mistake, and when the adjacent key is associated with the correct letter for the password, authorizes the user despite the typing mistake.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

While many embodiments described above employ software stored on the mobile device (either before being given to a subscriber, or during a subscriber call), the scripts and other software noted above may be hard coded into the mobile device (e.g. stored in EEPROM, PROM, etc.). Further, the above functionality may be implemented without scripts or other special modules.

The teachings of the system provided herein can be applied to other systems, not necessarily the system described above. The elements and acts of the various embodiments described above can be combined to provide further embodiments.

All of the above patents and applications and other references, including any that may be listed in accompanying filing papers, are incorporated by reference. Aspects of the system can be modified, if necessary, to employ the systems, functions, and concepts of the various references described above to provide yet further embodiments of the system.

These and other changes can be made to the system in light of the above Detailed Description. While the above description details certain embodiments of the system and describes the best mode contemplated, no matter how detailed the above appears in text, the system can be practiced in many ways. Details of the local-based support system may vary considerably in its implementation details, while still being encompassed by the system disclosed herein. As noted above, particular terminology used when describing certain features or aspects of the system should not be taken to imply that the terminology is being redefined herein to be restricted to any specific characteristics, features, or aspects of the system with which that terminology is associated. In general, the terms used in the following claims should not be construed to limit the system to the specific embodiments disclosed in the specification, unless the above Detailed Description section explicitly defines such terms. Accordingly, the actual scope of the system encompasses not only the disclosed embodiments, but also all equivalent ways of practicing or implementing the system under the claims.

While certain aspects of the system are presented below in certain claim forms, the inventors contemplate the various aspects of the system in any number of claim forms. For example, while only one aspect of the system is recited as embodied in a computer-readable medium, other aspects may likewise be embodied in a computer-readable medium. Accordingly, the inventors reserve the right to add additional claims after filing the application to pursue such additional claim forms for other aspects of the system.

The embodiments of the invention in which an exclusive property or privilege is claimed are defined as follows:

1. A method performed by a mobile device for presenting word candidates to a user based on a contact event within a key on a displayed keyboard, the method comprising:
detecting a contact event on a displayed keyboard or on a displayed candidate list. identifying whether the contact is a key tap of a key of the displayed keyboard, a path movement into a key of to the displayed keyboard, or a selection from a displayed candidate list;
determining whether the identified key is an alphabetic key or function key;
when the identified key is an alphabetic key, updating a current input sequence with the identified key;
identifying a group of one or more word candidates that correspond to the current input sequence, wherein identifying one or more word candidates includes:
identifying a word as a candidate if each of its initial letters is associated with a corresponding activated key in the input sequence;
identifying a word as a candidate if each of its initial letters is associated with a key that is adjacent to the corresponding activated key in the input sequence; and
for one or more identified candidate words, reducing a probability that a candidate word is an intended word by a determined factor for each letter that is associated with an adjacent key;
generating a tap candidate list of the identified group of one or more word candidates; and
displaying the generated tap candidate list to a user via a display of the mobile device.

2. The method of claim 1, wherein reducing a probability that a candidate word is an intended word by a determined factor for each letter that is associated with an adjacent key includes reducing the probability that the candidate word is the intended word by a determined percentage of a border that the adjacent key shares with a border of the activated key.

3. The method of claim 1, wherein reducing a probability that a candidate word is an intended word by a determined factor for each letter that is associated with an adjacent key includes reducing the probability that the candidate word is the intended word by a determined percentage of an area of overlap between the adjacent key and a circle centered at a center of the activated key that completely covers the activated key without completely covering any adjacent keys or partially covering any non-adjacent keys.

4. The method of claim 1, wherein reducing a probability that a candidate word is an intended word by a determined factor for each letter that is associated with an adjacent key includes reducing the probability that the candidate word is the intended word by a determined percentage of an area of overlap between the adjacent key and a circle centered at a center of the activated key that completely covers the activated key without completely covering any adjacent keys.

5. The method of claim 1, wherein reducing a probability that a candidate word is an intended word by a determined factor for each letter that is associated with an adjacent key includes reducing the probability that the candidate word is the intended word by a determined percentage of an area of overlap between the adjacent key and a circle centered at a point of contact within the activated key that completely covers the activated key.

6. The method of claim 1, wherein reducing a probability that a candidate word is an intended word by a determined factor for each letter that is associated with an adjacent key includes reducing the probability that the candidate word is the intended word by a determined percentage of an area of overlap between the adjacent key and a circle centered at a point of contact within the activated key having an area determined by a radius of a pre-determined value.

7. The method of claim 1, wherein reducing a probability that a candidate word is an intended word by a determined factor for each letter that is associated with an adjacent key includes reducing the probability that the candidate word is the intended word by a determined percentage of an area of overlap between the adjacent key and a circle centered at a point of contact within the activated key having an area approximating a contact area of a fingertip on a touch-screen of the mobile device displaying the activated key.

8. The method of claim 1, wherein identifying one or more word candidates includes reducing a probability that a candidate word is the intended word by a determined factor for each letter that is omitted from the current input sequence.

9. The method of claim 1, wherein identifying one or more word candidates includes reducing a probability that a candidate word is the intended word by a determined factor for each additional letter that is inserted in the current input sequence.

10. The method of claim 1, wherein identifying one or more word candidates includes reducing a probability that a candidate word is the intended word by a determined factor when the candidate word is of length (N+M), where M is greater than a determined threshold.

11. The method of claim 1, wherein identifying one or more word candidates includes increasing a probability that a candidate word is the intended word by a determined factor when the final letter of the candidate word is found to correspond with the final key of the current input sequence.

12. The method of claim 1, wherein identifying one or more word candidates includes increasing a probability that a candidate word is the intended word by a determined factor based on a relative frequency of use of the candidate word with respect to other candidate words.

13. The method of claim 1, further comprising:
clearing any input key sequences or candidate display lists associated with previously input text before or during the contact event.

14. The method of claim 1, wherein displaying the generated tap candidate list to a user via a display of the mobile device includes displaying the single most-probable candidate word at an insertion point within a text entry object displayed by the display of the mobile device.

15. The method of claim 1, wherein displaying the generated tap candidate list to a user via a display of the mobile device includes displaying two or more most-probable candidate words near an insertion point within a text entry object displayed by the display of the mobile device.

16. A system implemented by a computing device for determining a likelihood of intended contact for a key proximate to a contacted key of a displayed keyboard, the system comprising:
a contact event component, wherein the contact event component is configured to receive information associated with a contact event within a contacted key of a keyboard;
a candidate identification component, wherein the candidate determination component is configured to receive the information associated with the contact event and identify one or more key candidates for keys proximate to the contacted key based on a determined relationship factor between the contacted key and the keys proximate to the contacted key;
a calculation component, wherein the calculation component is configured to calculate probabilities of intended contact for each of the identified one or more key candidates; and
an output component, wherein the output component is configured to output the calculated probabilities.

17. The system of claim 16, wherein the output component is configured to output the calculated probabilities to a text entry application.

18. The system of claim 16, wherein the output component is configured to output the calculated probabilities to an access security application.

19. The system of claim 16, wherein the determined relationship factor between the contacted key and the keys proximate to the contacted key includes a percentage of a border that a key shares proximate to the contacted key shares with a border of the contacted key.

20. The system of claim 16, wherein the determined relationship factor between the contacted key and the keys proximate to the contacted key includes a percentage of an area of overlap between a key proximate to the contacted key and a circle centered at a center of the contacted key that completely covers the contacted key without completely covering any adjacent keys or partially covering any non-adjacent keys.

21. The system of claim 16, wherein the determined relationship factor between the contacted key and the keys proximate to the contacted key includes a percentage of an area of overlap between a key proximate to the contacted key and a circle centered at a center of the contacted key that completely covers the contacted key without completely covering any adjacent keys.

22. The system of claim 16, wherein the determined relationship factor between the contacted key and the keys proximate to the contacted key includes a percentage of an area of overlap between a key proximate to the contacted key and a circle centered at a point of contact within the contacted key that completely covers the contacted key.

23. The system of claim 16, wherein the determined relationship factor between the contacted key and the keys proximate to the contacted key includes a percentage of an area of overlap between a key proximate to the contacted key and a circle centered at a point of contact within the contacted key having an area determined by a radius of a pre-determined value.

24. The system of claim 16, wherein the determined relationship factor between the contacted key and the keys proximate to the contacted key includes a percentage of an area of overlap between a key proximate to the contacted key and a circle centered at a point of contact within the contacted key having an area approximating a contact area of a fingertip on a touch-screen of the computing device displaying the contacted key.

25. The system of claim 16, wherein the calculation component is configured to calculate the probabilities of intended contact for each of the identified one or more key candidates by multiplying the determined relationship factor by a weighting factor for a respective key candidate.

26. A computer-readable medium whose contents, when executed by a processor of a mobile device, cause the mobile device to perform a method for determining a most likely word candidate for a current key input sequence, the method comprising:
receiving information associated with a contact event within a contacted key of a keyboard displayed by a touch-screen of the mobile device, wherein the contact event causes a letter associated with the contacted key to be added to a current input sequence;
a key identification component, wherein the candidate determination component is configured to receive the information associated with the contact event and identify one or more key candidates for keys adjacent to the contacted key based on a determined relationship factor between the contacted key and the keys adjacent to the contacted key;
a calculation component, wherein the calculation component is configured to calculate probabilities of intended contact for each of the identified one or more key candidates; and
a word identification component, wherein the word identification component is configured to identify a group of one or more word candidates that correspond to the current input sequence by;
identifying a word as a candidate if each of its initial letters is associated with the contacted key in the current input sequence;
identifying a word as a candidate if each of its initial letters is associated with a key that is adjacent to the contacted key in the input sequence; and
reducing a probability that an identified word is a most likely word candidate based on the probabilities of intended contact calculated by the calculation component.
